(19) United States
(12) Patent Application Publication
(10) Pub. No.: US 2017/0130893 A1
(43) Pub. Date: May 11, 2017

(54) Pole Mounting Beam Clip

(71) Applicant: Jeff Wheelock, Monument, CO (US)

(72) Inventor: George Wichman, Westminster, CO (US)

(21) Appl. No.: 14/938,497

(22) Filed: Nov. 11, 2015

(51) Int. Cl. F16M 13/02; F16B 2/22

(52) U.S. Cl. CPC F16M 13/022; F16B 2/22

(57) ABSTRACT

A clip for mounting a cantilever beam to a pole where the beam has a free end and a fixed end and including a pressure pad secured to the fixed end of the beam and aligned with the longitudinal tension side of the beam and a planar hook secured to the fixed end of the beam proximate its longitudinal compression side.

The present invention relates generally to articles for attaching the fixed end of a load carrying cantilever beam to a near vertical or vertical pole or post.

### BACKGROUND

The prior art is replete with clips, clamps and fasteners designed to attach a load bearing platform to a rod or pole. For example, U.S. Pat. No. 6,279,208 to Gillis discloses a clip for a pole or cable that comprises a hook and a cam-shaped clamp between which the pole or cable is grasped.

Published U.S. Patent Application No. 2012/0217215 teaches a shower caddy system where each of a plurality of U shaped clips partially encircle a tension pole and the ends of the legs of the clips engage the wire construction of individual shelves.

U.S. Pat. No. 9,107,496 to Lindo et al. illustrates another type of pole caddy where the clamp that interconnects a shelf and a pole comprises a tubular member that encloses a section of the mounting pole and is secured to the pole by a screw type fastener.

While these and similar clips or clamps serve their purposes, they are not suited to anchoring the fixed end of a cantilever beam to a pole which may, at its free end, support a variety of objects such as a flower pot, shelf or other object. The pole fastening devices of the prior art not arranged for supporting the fixed end of a beam or rod. They are not easily detachable from the pole. They do not allow for, nor are they are not subject to rotation around the pole without adjustment or alteration of the clip.

Accordingly, the primary object of the present invention is to provide a simple clip that will couple the fixed end of a cantilever beam to a vertical pole, post or similar article and which will enable the cantilever beam to be easily raised or lowered on the pole and rotated to different radial positions with respect to the pole without adjustment of the fastening device. Another object of the invention is to provide a pole clip that is easily installed on or removed from the pole without adjusting or moving any parts of the clip. Other and further objects, features and advantages of the present invention will become apparent upon reading the following description of a preferred form of the invention taken together with the accompanying drawings.

### SUMMARY OF THE INVENTION

The clip of the present invention functions as the interconnection between a vertical pole and the fixed end of a cantilever beam. The beam may, most often, be load bearing along some portion of its length or at its free end. As with all cantilever beams, when loaded, the top portion of the beam is under tension while the lower portion of the beam is under compression. The compression force of the load is transferred to the pole by a pad attached to the fixed end of the beam in alignment with the lower portion of the beam. The tension force in the top portion of the beam is transferred to the pole through a hook that is attached to the fixed end of the beam and which engages the pole on the side of the pole opposite to the side receiving the compression load. The force transfer devices, the spaced apart pad and hook, comprise a force couple whose moment equals the moment in the beam created by the load on the beam. The pole can be of any cross section as long as the shape of the pad and the hook comport to the contours of the pole. For ease of explanation, the invention will be described in terms of a pole of circular cross section.

### DESCRIPTION OF THE DRAWINGS

FIG. 1 is a perspective view of a flower pot caddy, a typical apparatus employing the pole mounted beam clip of the present invention.

FIG. 2 is an enlarged fragmentary perspective view of a cantilever beam whose fixed end mounts the pole clip of the present invention.

FIG. 3 is a free body diagram of a cantilever beam having a free end and two points of attachment to a support at is other end, similar to the cantilever bean

### DETAILED DESCRIPTION OF A PREFFERED FORM OF THE INVENTION

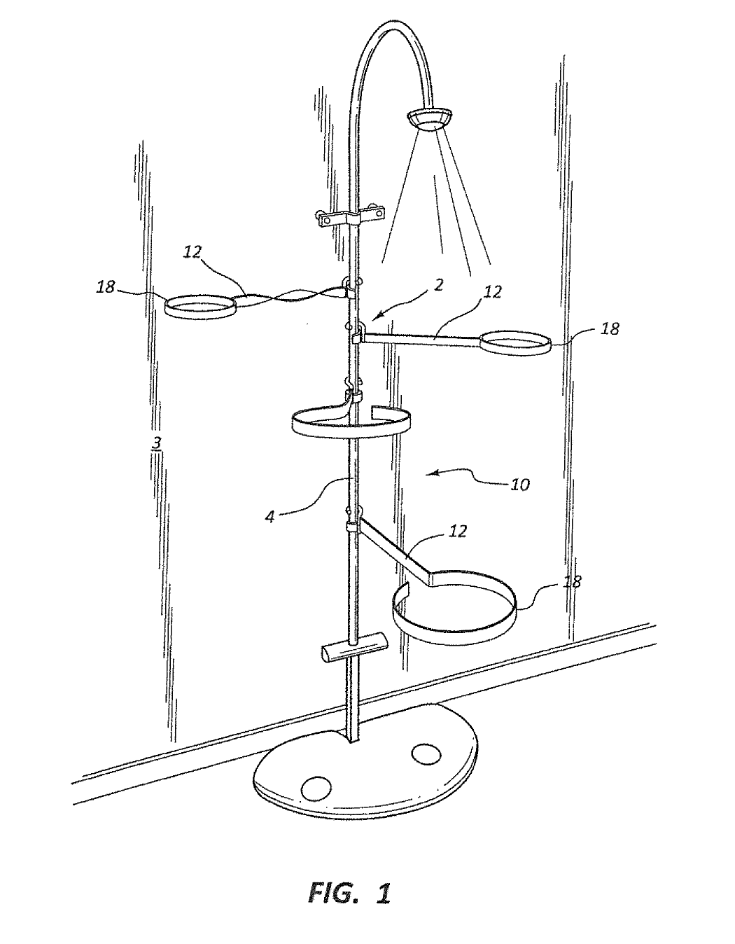

The flower pot caddy 10 shown in FIG. 1 illustrates an exemplary use of the beam clip of the present invention. A vertical pole 4 is supported against a wall 3 and carries a plurality of flower pot holders 18. The pot holders are attached to the free ends of cantilever beams 12, the fixed ends of which are attached to the vertical pole 4 by clips 2.

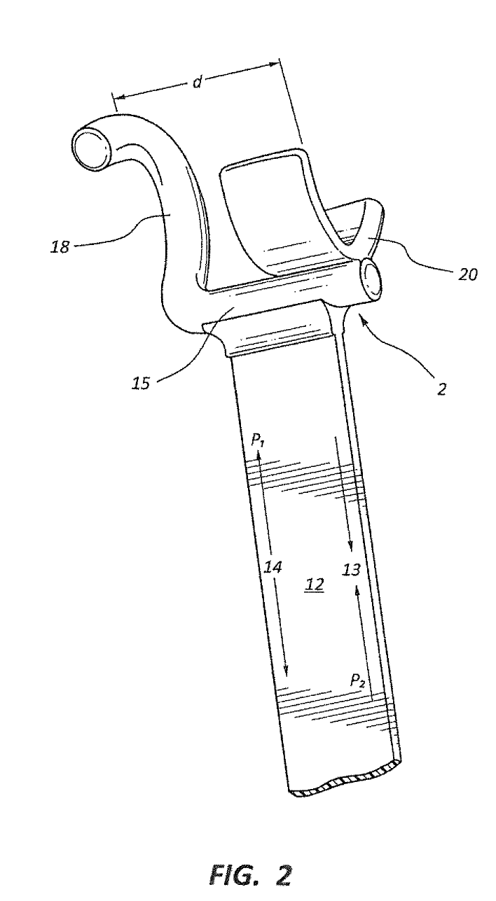

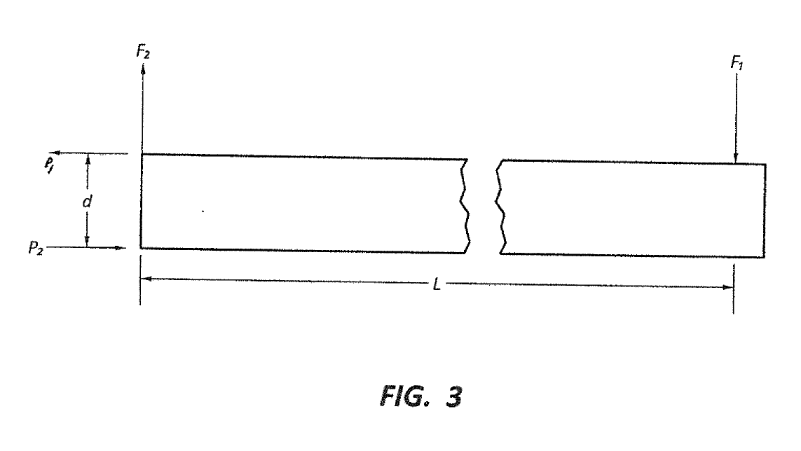

The enlarged view of FIG. 2 shows the cantilever beam 12 and the clip 2 of the present invention. When the free end of the beam 12 is loaded with a flower pot or similar article, the lower side 13 of the beam transfers the compressive force of the flower pot load to the pole 4 through an arcuate pad 20 which provides resistant force P₂. The pad is attached to the fixed end of the beam in alignment with the compression force in the beam and engages the front side of the pole 4. The tension force in the upper portion 14 of the beam is transferred to the pole by means of a hook 18 that engages the back side of the pole 4 which provides a resistant force P₁. The arcuate pad 20 and the hook 18 may be attached to the fixed end of the beam in a number of different configurations as long as they are sufficiently spaced apart to provide the necessary moment to balance the moment created by the force of the pot times the length of the beam, as shown in FIG. 3. The preferred form of attachment is shown in FIG. 2 where it is assumed that the width of the beam 12 is insufficient to provide the necessary spacing between the force transfer devices, the pad 20 and the hook 18.

The specifications of the beam depend on the load to be carried at the end of the beam and the desired length of the beam. This load creates a clockwise moment. In many instances the predicted load and esthetic desirable length of the beam will result in a beam or rod of insufficient width to properly space the force transfer devices 20 and 18 to create the necessary force couple. FIG. 2 illustrates such a case, requiring an extension of the beam width at the point of interconnection between the force transfer devices and the fixed end of the beam. In the preferred embodiment such extension is achieved by bending an extended end of the planar hook 18 to form an elongated base member 15 that is perpendicular to the plane of the arcuate hook 18. The base member 15 is secured to the fixed end of the beam and its elongated dimension provides a base having sufficient effective spacing d between the pad 20 and hook 18 to provide the necessary counterclockwise moment that is equal to, and opposite the clockwise moment.

As seen, the vertical spacing d between the hook 18 and the pad 20 creates the counter clockwise moment that keeps the beam in rotational equilibrium. In turn, in order to keep the beam in horizontal equilibrium, the pole imposes equal and opposite forces thru the force transfer devices 18 and 20. The pole 4 also imposes an upward force F₂ which equal to an opposite the downward force F₁ created by the load on the free end of the beam. The magnitude of the upward force F₂ is created by the friction force at the contact surfaces between the pole and transfer devices

The free body diagram of FIG. 3 illustrates the forces and moments existing in the loaded beam where F₁ is the force of the load on the beam and L is the length of the beam from its fulcrum to the center of the F₁ force. P₁ and P₂ are equal and opposite forces exerted by the pole at the points of pole contact with the hook and the pad respectively, displaced by the perpendicular distance d between the hook and the pad. These forces impose a moment, or torque, about an axis which is normal to the plane of the forces whose lines of action are separated by distance d.

Since P₁ and P₂ are equal, the magnitude of the torque M is: M=Pd where P is the vertical down load carried by the cantilever beam. In turn, the equal and opposite moments are F₁L=Pd, where Pd is the counterclockwise moment the pole exerts on the cantilever beam. Thus, it is seen that the hook 18 and pad 20, separated by distance d, counteract the force moment created by the load F₁ on the beam 12.

The arc of the pad 20 and the curve of the hook 18 accommodate the periphery of the pole 4 to facilitate rotation of the beam around the pole, that is, to place the beam in different radial positions relative to the pole and to increase the area of contact between the pole's surface and the pad and hook.

The cantilever beam is easily removed from the pole by raising the free end of the beam to disengage the pad 20 from contact with the pole and then removing the hook 18 from contact with the pole. Installation requires the opposite moves.

Raising or lower the beam on the pole is accomplished by slightly raising the free end of the beam to slightly separate the pad and the pole and then by applying the appropriate pressure, the beam may be moved up and down the pole without having to remove the beam from the pole.

All of the objects of the present invention are achieved by the combination described above.

I claim:

1. A pole mounting beam clip comprising,
a cantilever beam having a fixed end and a free end and having longitudinal tension and compression sides,
a pressure pad secured to the fixed end of the beam and aligned with its tension side.
a planar hook secured to the fixed end of the beam proximate its compression side.

2. The beam clip of claim 1 where the planar hook includes an integral base member disposed perpendicularly to the plane of the hook.

3. The beam clip of claim 2 where the integral base member is attached to the fixed end of the cantilever beam.

4. The beam clip of claim 3 where the pressure pad is attached to the integral base member.

5. The beam clip of claim 1 where the pressure pad is arcuate.

6. The beam clip of claim 5 where the planar hook is arcuate.

7. A pole mounting clip for a cantilever beam having a free end and a fixed end, comprising,
spaced apart tension and compression force transfer devices attached to the fixed end of the cantilever beam, comprising a hook and a pad respectively.
